(19) United States
(12) Patent Application Publication
(10) Pub. No.: US 2011/0058791 A1
(43) Pub. Date: Mar. 10, 2011

(54) RECORDING CONTROLLER AND RECORDING CONTROL METHOD

(75) Inventor: Katsumi KAGA, Fukaya-shi (JP)

(73) Assignee: KABUSHIKI KAISHA TOSHIBA, Tokyo (JP)

(21) Appl. No.: 12/842,915

(22) Filed: Jul. 23, 2010

(30) Foreign Application Priority Data
Sep. 4, 2009 (JP) 2009-205288

(51) Int. Cl. H04N 5/76

(52) U.S. Cl. 386/291; 386/E05.003

(57) ABSTRACT

A recording controller includes: a presentation module configured to perform a presentation for simultaneously presenting a first item for selecting each broadcast channel to be recorded from a plurality of broadcast channels and a second item for setting each recording time range in accordance with the selected broadcast channel; a table configured to store each broadcast channel selected and each recording time range set based on the presentation; and a recording control module configured to control recording of signals of the selected broadcast channels on a recording medium in accordance with the table.

### CROSS-REFERENCE TO THE RELATED APPLICATION(S)

The present application is based upon and claims priority from prior Japanese Patent Application No. 2009-205288, filed on Sep. 4, 2009, the entire contents of which are incorporated herein by reference.

### BACKGROUND

1. Field

The present invention relates to a recording controller and a recording control method.

2. Description of the Related Art

Interest in an automatic video recorder has increased with the increase in the capacity of a recording medium (e.g. an HDD (Hard Disk Drive)) mounted in a video recorder. In the automatic video recorder, video/audio signals of a plurality of channels can be recorded continuously and simultaneously (simultaneous recording or entire recording) without user's setting programs to be recorded. For example, all one-week's programs of all receivable channels are recorded on an HDD.

There has been disclosed a technique called “loop recording” for performing repeat overwrite recording in a special area defined separately from a normal recording area independently of normal recording. An example of such technique is disclosed in JP-A-2008-165859 (counterpart U.S. publication number is: US 2008/0159709 A1).

The recordable time in simultaneous recording basically depends on the capacity of a recording medium used for recording and the quality of pictures to be recorded.

However, for example, the simultaneous recordable range is limited to a range corresponding to one day due to the capacity of the recording medium.

### BRIEF DESCRIPTION OF THE DRAWINGS

A general configuration that implements the various features of the present invention will be described with reference to the drawings. The drawings and the associated descriptions are provided to illustrate embodiments of the invention and not to limit the scope of the invention.

FIG. 1 is a block diagram showing a configuration of a video recording system according to an embodiment of the invention.

FIG. 2 is a schematic diagram showing an example of meta-data.

FIG. 3 is a schematic diagram showing program information stored in a program database.

FIG. 4 is a schematic diagram showing an example of a menu screen for setting simultaneous recording.

FIG. 5 is a schematic diagram showing an example of an input screen for setting ON/OFF of simultaneous recording.

FIG. 6 is a schematic diagram showing an example of an input screen for making channel setting.

FIG. 7 is a schematic diagram showing an example of an input screen for making day-of-week setting.

FIG. 8 is a schematic diagram showing an example of an input screen for making time setting.

FIG. 9 is a schematic diagram showing an example of an input screen for making priority setting.

FIG. 10 is a schematic diagram showing an example of an input screen for setting priority in accordance with each program category.

FIG. 11 is a schematic diagram showing an example of a screen for displaying the number of continuously recordable days.

FIG. 12 is a schematic diagram showing another example of the menu screen for setting simultaneous recording.

FIG. 13 is a schematic diagram showing another example of the input screen for making time setting.

FIG. 14 is a schematic diagram showing an example of an input screen for setting a start time and an end time.

FIG. 15 is a schematic diagram showing an example of a program table of simultaneously recorded programs.

FIG. 16 is a schematic diagram showing an example of a screen for designating airdates of programs to be reproduced.

### DETAILED DESCRIPTION

An embodiment according to the present invention will be described in detail with reference to the accompanying drawings. The scope of the claimed invention should not be limited to the examples illustrated in the drawings and those described below.

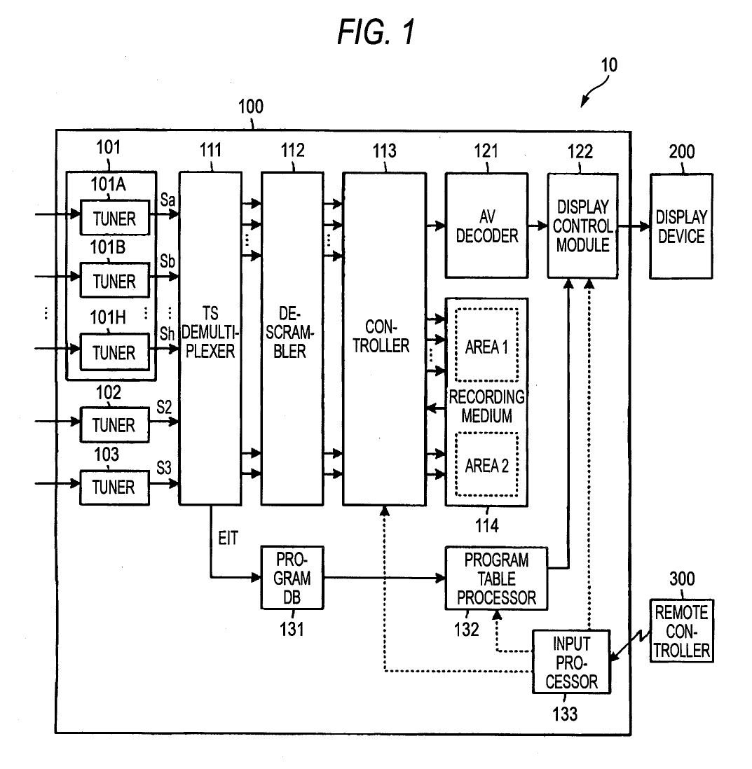

FIG. 1 is a block diagram showing a configuration of a video recording system 10 according to an embodiment of the invention. The video recording system 10 has a video recorder 100, a display device 200, and a remote controller 300.

The video recorder 100 is an apparatus (such as a recorder or a digital TV set) which performs simultaneous recording of broadcast signals (simultaneous recording of signals of a plurality of channels), normal recording of a broadcast signal (individual recording of a signal of a single channel) and reproducing of each of the broadcast signals. That is, the video recorder 100 can record and reproduce signals of a plurality of selected channels or a signal of a single selected channel for a period from a designated start time to a designated end time.

The display device 200 is an external monitor, such as a liquid crystal display device and a plasma display device. The remote controller 300 transmits a radio (infrared ray or electric wave) signal for controlling the video recorder 100 based on user's command input.

The video recorder 100 has tuners 101 (101A to 101H), 102 and 103, a TS demultiplexer 111, a descrambler 112, a controller 113, a recording medium 114, an AV decoder 121, a display processor 122, a program database 131, a program table processor 132, and an input processor 133.

Each of the tuners 101, 102 and 103 selects a TS (Transport Stream) from a broadcast signal (e.g. digital terrestrial broadcasting or BS/CS digital broadcasting) in accordance with each of signals Sa to Sh, S2 and S3 of channels (CH) and outputs the TS to the TS demultiplexer 111.

The tuner 101 is a simultaneous recording tuner module for selecting and outputting video and audio signals of a plurality of channels simultaneously as a whole and serves as a selection portion which selects signals of a plurality of channels from broadcast signals. The tuner 101 has eight tuners 101A to 101H which select signals Sa to Sh of single channels respectively. The start and end of recording of these signals Sato Sh are controlled not individually but collectively.

The tuners 102 and 103 are normal recording tuner modules which select signals S2 and S3 of single channels respectively and serve as a second selection portion which selects a signal of a single channel from broadcast signals. The start and end of recording of the signals S1 and S2 are controlled individually (independently of each other).

The TS demultiplexer 111 demultiplexes the signal (TS) of each channel into an ECM (Entitlement Control Message) which is encoded information and an EIT (Event Information Table) which is a table in which event information such as program name, category (e.g. movie, sports or news), cast, start time, end time, etc. is written. Use of the EIT will be described later.

The descrambler 112 descrambles the signal (TS) of each channel and outputs the descrambled signal to the controller 113.

The controller 113 records the descrambled TS on the recording medium 114. The controller 113 reproduces the TS which is the signal of the broadcast program recorded on the recording medium 114, and outputs the reproduced TS to the AV decoder 121.

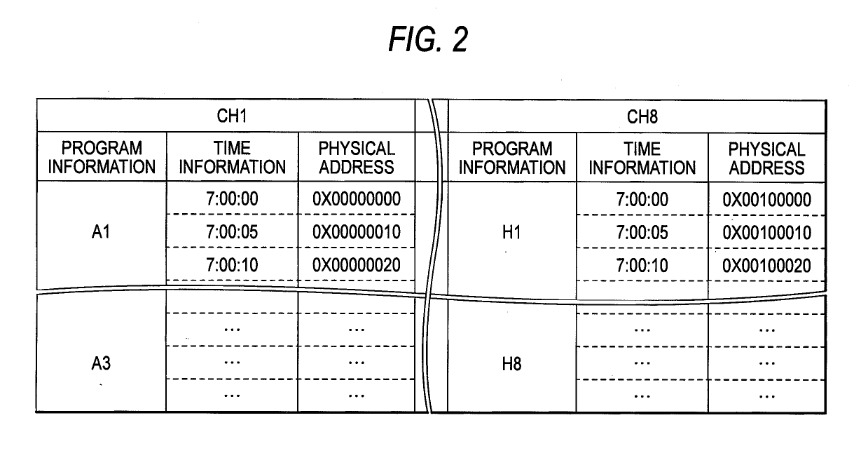

The controller 113 generates meta-data in accordance with each channel and records the meta-data together with the signal of the broadcast program on the recording medium 114. FIG. 2 shows an example of meta-data. The meta-data is data in which a recording position (physical address) in a physical area of the recording medium 114 is associated with time information and program information. On this occasion, program information, time information and a physical address are indicated while associated with one another with respect to each of channels CH1 to CH8 corresponding to the simultaneous recording tuner 101 (101A to 101H) (for recording signals Sa to Sh). In this example, the recording position (physical address) is recorded at intervals of 5 sec. Incidentally, the program information can be acquired from the EIT.

On the other hand, in normal recording, meta-data is generated in accordance with each program and recorded together with a signal of a broadcast program on an area A2 of the recording medium 114. Classification of meta-data and the area A2 for storing meta-data in normal recording are different from classification of meta-data and the area A1 for storing meta-data in simultaneous recording. Meta-data in simultaneous recording and meta-data in normal recording correspond to a plurality of channels and a single channel respectively.

The controller 113 serves to function as the following modules:

a recording control module that controls recording of the signals of the selected channels on the recording medium in accordance with a table;

a deletion module that deletes the signals of the selected channels from the recording medium in accordance with priority.

A second recording control module that controls recording of a signal of a single channel on the recording medium in accordance with a third table; and

an area reservation module that reserves a first area for recording the signals of the plurality of channels and a second area for recording the signal of the single channel in the recording medium in accordance with third information.

The recording medium 114 is a recording medium such as an HDD, an optical disk, an SD (registered trademark) card, etc. The TS as a broadcast signal from the controller 113 is recorded on the recording medium 114. The recording medium 114 may be not built in the video recorder 100 but connected to the video recorder 100 through a USB (Universal Serial Bus), a LAN (Local Area Network) or the like.

The recording medium 114 has areas A1 and A2 corresponding to simultaneous recording and normal recording respectively.

The recording medium 114 records the following tables:

a table for storing selected broadcast channels and set recording time ranges;

a second table indicating priorities of signals of channels to be recorded on the recording medium; and

a third table indicating a single broadcast channel and a second recording time range for recording a signal of this broadcast channel.

The AV decoder 21 decodes the signal selected by the tuner 101, 102 or 103 or the signal reproduced by the controller 113 to AV information (video and audio) and outputs the AV information to the display processor 122.

The display processor 122 outputs the AV information to the display device 200 to display video. The display processor 122 further has a GUI (Graphical User Interface) function for presenting information to the user by OSD (On Screen Display) or the like. By this GUI function, a menu, a program table or the like which will be described later is displayed on the display device 200. The display processor 122 serves as a presentation module which simultaneously presents a first item for selecting broadcast channels to be recorded from a plurality of broadcast channels and a second item for setting a recording time range in each selected broadcast channel.

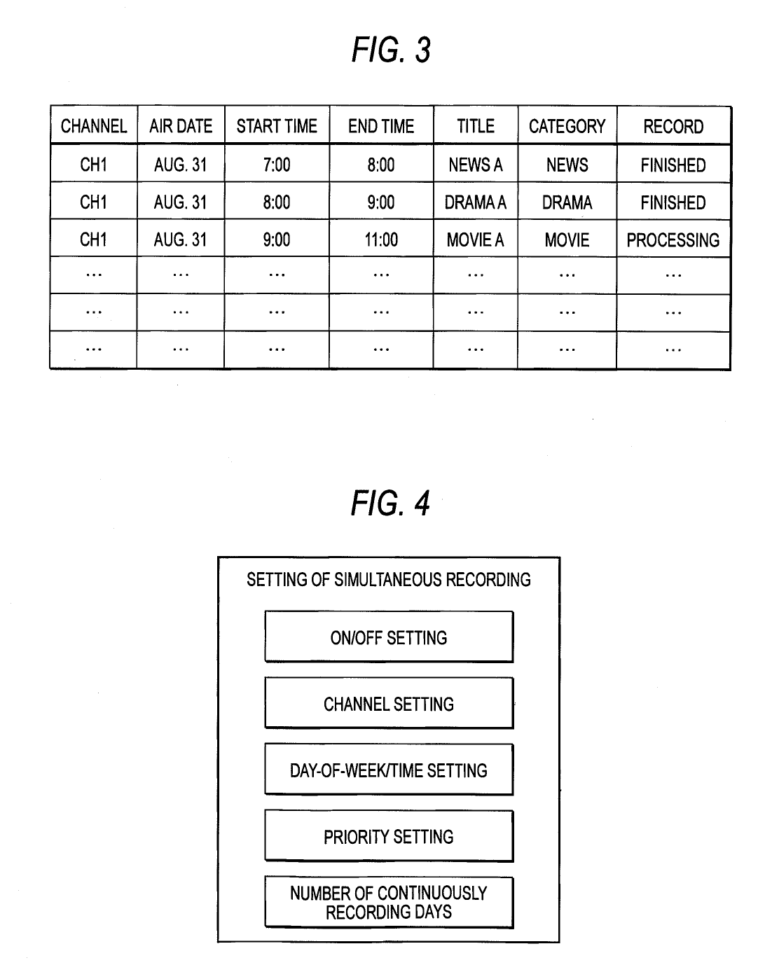

The program database 131 receives the EIT separated by the TS demultiplexer 111 and stores the EIT as program information. The program database 131 serves as a storage module which stores program information contained in the signals of the selected channels. FIG. 3 is a schematic diagram showing program information stored in the program database 131. As shown in FIG. 3, information such as channel, date, start time, end time, title, category, recording state, etc. is stored in accordance with each program.

The program table processor 132 receives program information (information of programs which have been recorded on the recording medium 114 and information of programs which will be broadcast in the future) from the program database 131 and generates a program table. The program table processor 132 serves as a generating module which generates a program table corresponding to a plurality of channels from stored program information.

The input processor 133 accepts various kinds of user's inputs (setting of simultaneous recording and designation of a program to be reproduced on the program table) given from the remote controller 300. Incidentally, the input processor 133 may accept user's inputs given from a stationary operation panel (not shown) attached to the video recorder 100.

The input processor 133 serves as an input module which inputs information indicating the presence or absence of recording of the signals of the selected broadcast channels on the recording medium.

The operation of the video recording system 10 will be described below.

### A. Setting of Simultaneous Recording

Setting of simultaneous recording starts in response to an input given from the input processor 133.

FIG. 4 is a schematic diagram showing an example of a menu screen for setting simultaneous recording. Items “ON/OFF setting”, “channel setting”, “day-of-week/time setting”, “priority setting” and “display of the number of continuously recording days” are displayed on the menu screen. Any one of these items can be selected by use of the remote controller 300. A table indicating a time range, priority, etc. is generated in accordance with the selected item and held in the recording medium 114.

### (1) ON/OFF Setting of Simultaneous Recording

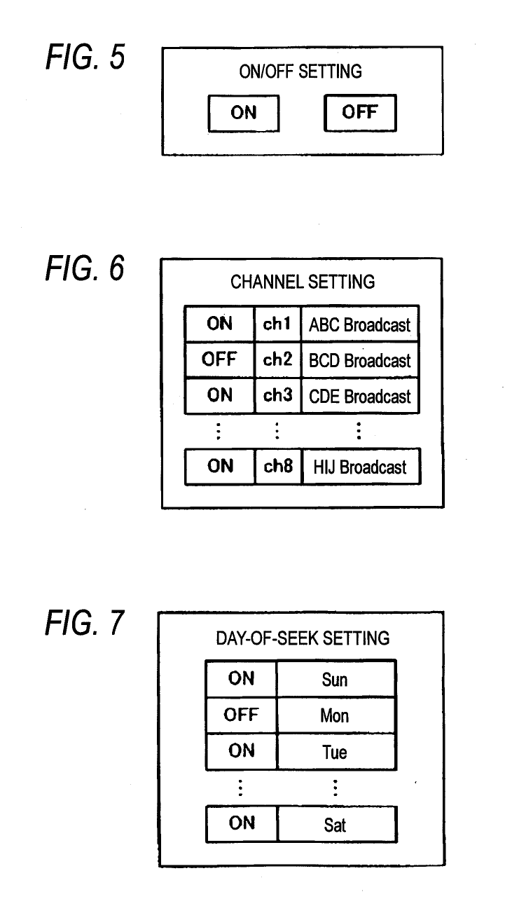

When “ON/OFF setting” is selected on the menu screen, an input screen shown in FIG. 5 is popped up so that ON/OFF of simultaneous recording can be set. An “ON” button or an “OFF” button can be selected on this input screen by use of the remote controller 300. Incidentally, simultaneous recording may be set to ON in an initial state where ON/OFF of simultaneous recording has not been set yet.

When simultaneous recording is set to be ON, the areas A1 and A2 are reserved in the recording medium 114. On the other hand, when simultaneous recording is set to be OFF, only the area A2 is reserved in the recording medium 114. Because the area A1 is not required, the area A2 can be kept wide.

When simultaneous recording is changed from OFF to ON as a result of this setting, a part of the area A2 can be deleted and allocated to the area A1. On the other hand, when simultaneous recording is changed from ON to OFF, the area A1 per se can be deleted and allocated to the area A2 so that the area A2 can be widened.

When simultaneous recording is set to be ON, the following various kinds of settings (2) to (5) are enabled. Incidentally, when simultaneous recording is set to be OFF, the following settings can be disabled from being selected.

### (2) Setting of Channel

When “channel setting” is selected on the menu screen, an input screen shown in FIG. 6 is popped up so that each channel can be set. That is, allocation of channels to the tuners 101A to 101H and ON/OFF of the channel setting are determined. In FIG. 6, channels ch1 to ch8 (ABC broadcast to HIJ broadcast) are allocated to the tuners 101A to 101H respectively. The channel ch2 is allocated to the tuner 101B but the channel setting for the channel ch2 is OFF, so that the TS from the tuner 101B is not recorded. That is, ON/OFF in the “channel setting” controls the presence or absence of recording of the TS from each of the tuners 101A to 101H.

### (3) Setting of Day-Of-Week/Time

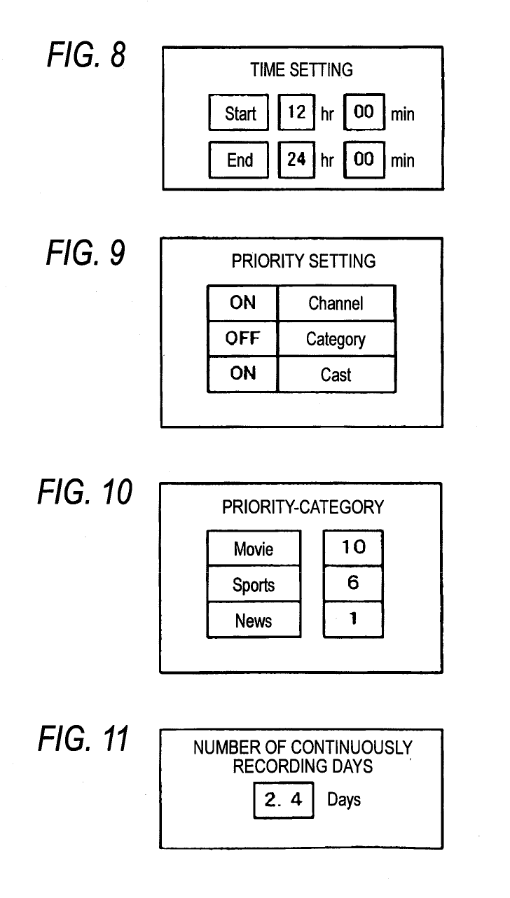

When “day-of-week/time setting” is selected on the menu screen, an input screen shown in FIG. 7 is popped up so that a day of the week can be set. When setting in the input screen shown in FIG. 7 is then terminated, an input screen shown in FIG. 8 is popped up so that a time can be set.

The “day-of-week setting” screen is provided for selecting the presence or absence of recording on each day of the week. In this example, recording is present on Sunday and Tuesday to Saturday but recording is absent on Monday.

The “time setting” screen is provided for inputting the start time and end time of recording every day. In this example, the start time and end time of recording are 12:00 and 24:00 respectively so that recording can be continued for 12 hours.

In the “day-of-week/time setting”, a recording time range (a day of the week or a time) common to the tuners 101A to 101H in a broad sense can be set. That is, outputs of the tuners 101A to 101H can be turned ON/OFF simultaneously in accordance with the timing designated by the “day-of-week/time setting”.

### (4) Setting of Priority

When “priority setting” is selected on the menu screen, a “priority setting” input screen shown in FIG. 9 is popped up so that ON/OFF of each of items for which priority is provided can be set.

This priority is a parameter indicating the level of importance of each recorded program. As will be described later, programs are deleted from the recording medium 114 in order of lower priority. In this example, priorities with respect to channels, categories and casts can be set.

When, for example, “category” is turned ON in the “priority setting” input screen, an input screen shown in FIG. 10 is popped up so that priority can be set in accordance with each program category. In this example, priorities of 10, 6 and 1 are set for movie, sports and news respectively. Incidentally, this priority setting is only one instance.

As described above, priorities with respect to a plurality of items can be set. When the priorities are set in this manner, priority Pt in accordance with each program is calculated, for example, by use of the following Expression (1).

Pt=P1*P2*P3 (1)

In the Expression (1), P1 is priority with respect to item 1, P2 is priority with respect to item 2, and P3 is priority with respect to item 3.

Incidentally, priority with respect to an item set to be OFF is regarded as 1.

As will be described later, programs recorded on the recording medium 114 are deleted based on the priority Pt calculated by the Expression (1).

### (5) Display of the Number of Continuously Recording Days

When “number of continuously recording days” is selected on the menu screen, the number of continuously recordable days is displayed (FIG. 11).

The aforementioned screens may be replaced by other menu screens.

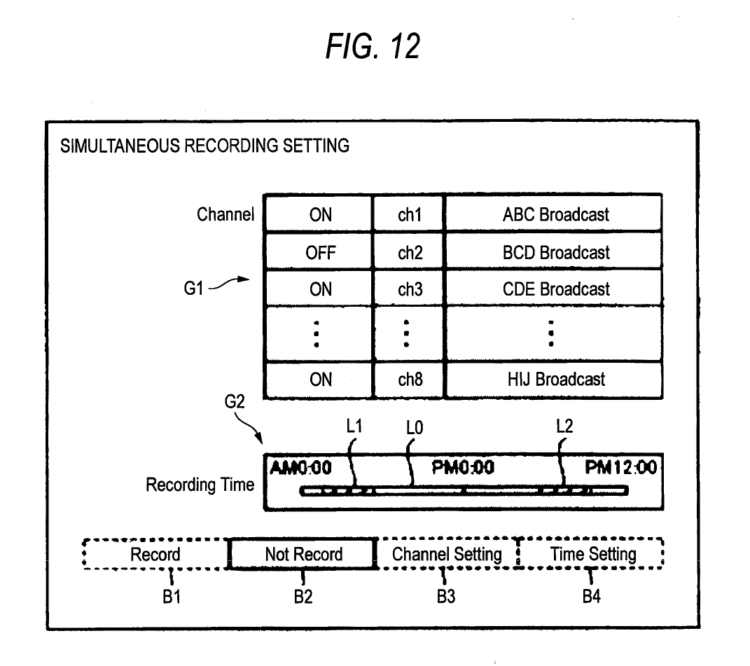

FIG. 12 is a schematic diagram showing another example of the menu screen for setting simultaneous recording. The presence or absence (ON/OFF) of simultaneous recording can be set on this screen by use of buttons B1 and B2. Channel setting and time setting can be selected by use of buttons B3 and B4.

In addition, the setting state of each channel and the setting state of the recording time can be confirmed simultaneously in FIG. 12. Display areas G1 and G2 indicating the setting state of each channel and the setting state of the recording time respectively are displayed. Channels (ch1 to ch8), broadcast stations (ABC broadcast to HIJ broadcast) and the presence or absence (ON/OFF) of recording in accordance with the respective tuners 101A to 101H are displayed in the display area G1. Bars L0, L1 and L2 are displayed in the display area G2. The bar L0 corresponds to a range of from 0:00 AM to 12:00 PM. The bars L1 and L2 indicating set recording times are displayed in the bar L0.

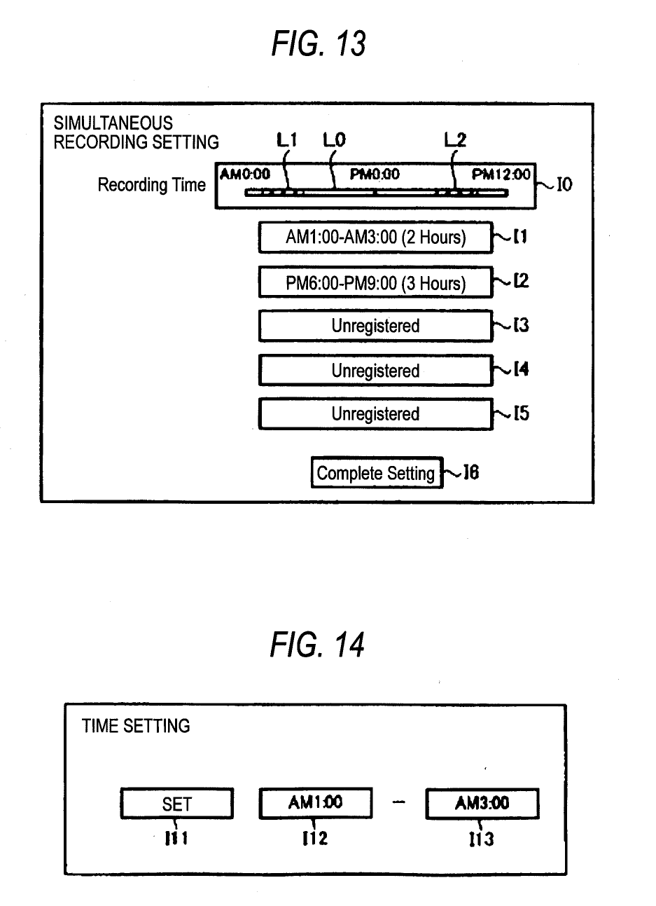

FIG. 13 is a schematic diagram showing another example of the “time setting” menu screen. A display area G3 and icons I1 to I6 are displayed on the screen.

The display area G3 indicates the state of time setting, similarly to the display area G2 in FIG. 12. That is, the bars L1 and L2 indicating set recording times are displayed in the bar L0 corresponding to a range of from 0:00 AM to 12:00 PM. The bars L1 and L2 correspond to recording times set in the icons I1 and I2 respectively.

Each of the icons I1 to I5 is provided for setting and displaying the start time and end time of recording. When one of the icons I1 to I5 is selected by use of the remote controller 300, an input screen shown in FIG. 14 is popped up. Icons I11 to I13 are displayed in the input screen. The icon I11 indicates completion of inputting of the start time and end time. The icons I12 and I13 are icons for inputting the start time and end time respectively. When the start time and end time are inputted by use of the icons I12 and I13 and the icon I11 is clicked, the screen shown in FIG. 13 is displayed again.

Incidentally, recording times overlapping with one another can be set in the icons I1 to I5. In this case, the recording times are treated collectively. When, for example, recording times “5:00 PM-9:00 PM” and “8:00 PM-11:00 PM” are set in accordance with the icons I3 and I4 respectively, “8:00 PM-9:00 PM” is a range where the recording times in the icons I3 and I4 overlap with each other. In this case, recording will be performed continuously on the whole “5:00 PM-11:00 PM” of the recording times set in the icons I3 and I4. That is, the same operation as that in the case where 5:00 PM and 11:00 PM are set as the start time and end time respectively is obtained, so that ON/OFF operation will not be performed at the end time 9:00 PM of the icon I3 and the start time 8:00 PM of the icon I4.

### B. Simultaneous Recording

Simultaneous recording is executed in accordance with the settings. That is, signals output from the tuners 101A to 101H are recorded in accordance with the “channel setting” and the “day-of-week/time setting”. That is, the presence or absence of recording of signals from the tuners 101A to 101H is controlled collectively in accordance with the day-of-week/time setting with respect to the set channels. Incidentally, on-air programs may be reproduced while recorded simultaneously (simultaneous recording and reproduction).

As described above, when a plurality of recording times are set, the presence or absence of recording of signals from the tuners 101A to 101H is not controlled in a recording time overlapping range. As a rule, recording starts and ends in accordance with the recording start time and recording end time set in each of the icons I1 to I5. However, overlapping of the recording times is checked at the time of the start and end so that control of the start and end of recording is stopped in a recording time overlapping range.

As described above, channels to be recorded and a day of the week and a time based on which each channel will be recorded can be set for simultaneous recording. As a result, for example, recording can be performed for a time not shorter than one day on the area A1 having a storage capacity corresponding to one day. Specifically, broadcasts of 6 channels can be recorded continuously and simultaneously for 24 hours on the area A1. When the user does not need to record programs for a time of from 0:00 to 12:00, only programs for a time of from 12:00 to 24:00 can be recorded. The capacity of the area A1 used in this case can be reduced to a half. Therefore, when the remaining half not used in this case can be further used effectively, recording for “2 days” can be performed though recording for only “24 hours=1 day” could conventionally be reserved.

For example, in the case of an apparatus capable of recording of all channels can be continued for 24 hours (an entire day) every day, the number of continuously recordable days is 4 when the number of channels is set to a half and the recording time is set to a half.

### C. Deletion of Programs

When the capacity of the recording medium 114 becomes insufficient, old signals (TS) of channels are deleted as a lump of signals corresponding to a predetermined time (for example, of 30 minutes) from the area A1 successively. When, for example, the area A1 has a capacity corresponding to 24 hours, recording is performed so that old signals (TS) of channels over 24 hours are overwritten with new signals (TS) of channels.

On this occasion, a set priority can be added to a deletion sequence of programs. That is, programs to be deleted are determined based on both the time which has passed after recording and the set priority. In this manner, user's favorite programs can be preserved for a time as long as possible.

For example, programs are deleted in ascending order of an importance factor R calculated based on the following Expression (2).

R=Pt/T (2)

In the Expression (2), Pt is priority which is calculated based on the Expression (1), and T is the time which has passed after recording.

### D. Creation of Program Table

A program table of simultaneously recorded programs can be generated and displayed.

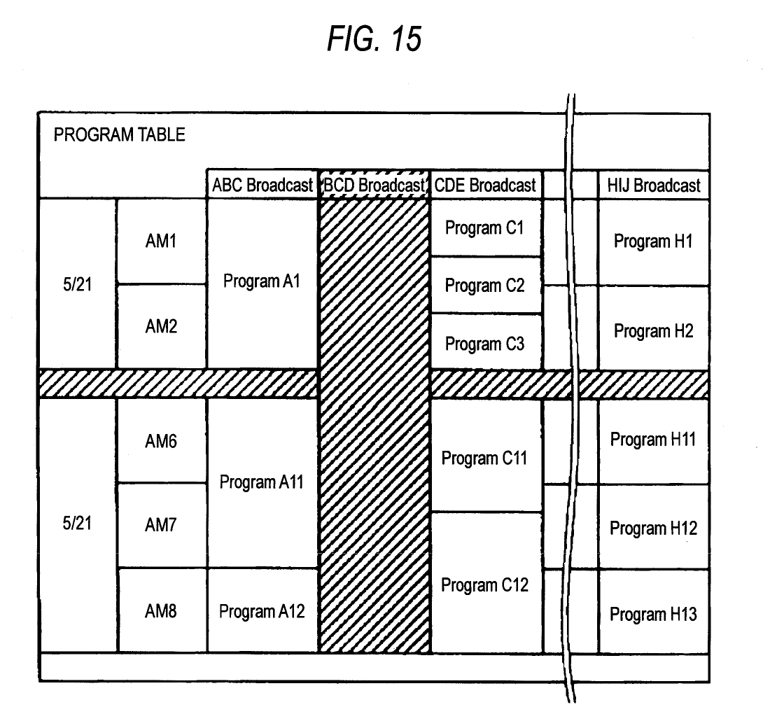

FIG. 15 is a front view showing an example of display of a program table. In this program table, a time axis is set in the vertical direction of the screen and columns indicating broadcast stations (“ABC broadcast” to “HIJ broadcast”) are set in the horizontal direction of the screen. Airdates, broadcast times and programs are indicated accordingly.

Channels and the presence or absence of recording time setting are shown in the program table. In this example, broadcast time “3:00 AM-6:00 PM” and “BCD broadcast” are grayed down because they are not a subject of recording. These items not a subject of recording may be deleted from this screen. This example shows the case where recording is not performed for a specific broadcast time. When the presence or absence of recording is set in accordance with each day of the week, channels and the presence or absence of recording time setting can be displayed in the same manner in accordance with each day of the week.

### E. Reproduction of Program

Simultaneously recorded programs can be subjected to a process such as reproduction as follows.

(1) Playback, stop, pause
(2) Special playback (fast forward/fast backward)
(3) Skip operation (jump to the head of a previous or next program)
(4) Continuous playback inclusive of previous and next programs
(5) Information display (title, detailed information, copy generation information, etc.)

A program to be reproduced can be selected by use of the program table. When a program is selected from the program table, processing is performed as follows.

The controller 113 retrieves meta-data corresponding to the channel and start time of the selected program from the recording medium 114 and calculates the playback start position of the channel based on the retrieved meta-data.

Data (TS) of the calculated playback start position is read from the recording medium 114.

The read TS is input to the AV decoder 121 so that video of the program selected from the program table is displayed and played back on the display device 200.

An airdate may be designated in place of the program to play back the program.

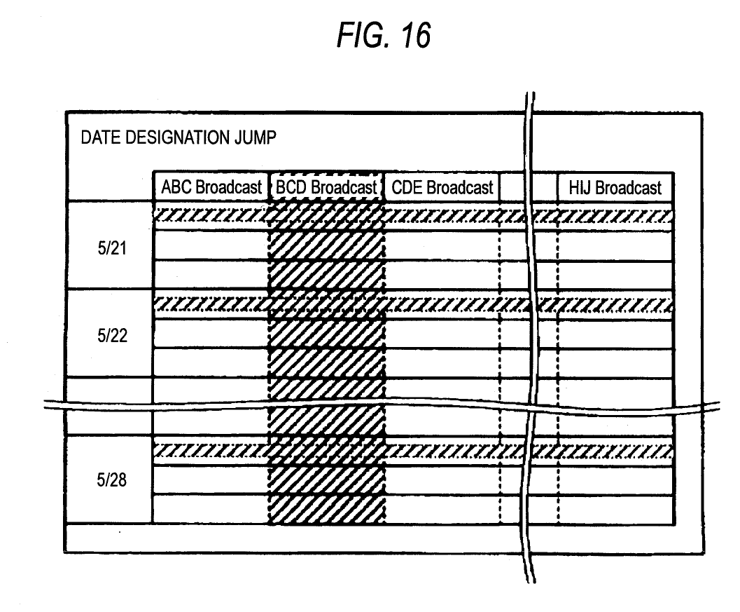

FIG. 16 shows a screen for designating the airdate of a program to be reproduced (date designation jump). In this example, a day is classified into three time zones so that a program can be selected from each time zone. In this example, the broadcast time and channel (“BCD broadcast”) not a subject of recording are grayed down.

The embodiment of the invention is not limited to the aforementioned embodiment and can be extended or changed so that the extended or changed embodiments are included in the technical scope of the invention.

For example, components (the tuners 101, 102 and 103, the TS demultiplexer 111, the descrambler 112, the controller 113, the AV decoder 121, the program database 131, the program table processor 132 and the display processor 122) of the video recorder 100 may be implemented by hardware or may be implemented by software. That is, a processor (not shown) which serves as a control module, and software programs stored in a storage module (not shown) can be used for achieving the video recorder 100.

Although the embodiment according to the present invention has been described above, the present invention is not limited to the above-mentioned embodiments but can be variously modified. Constituent components disclosed in the aforementioned embodiment may be combined suitably to form various modifications. For example, some of all constituent components disclosed in the embodiment may be removed, replaced, or may be appropriately combined with other components.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A recording controller comprising:
a presentation module configured to simultaneously present a first item for selecting a broadcast channel to be recorded from a plurality of broadcast channels and a second item for setting a recording time range in accordance with the selected broadcast channel;
a table configured to store the selected broadcast channel and the recording time range; and
a recording controller configured to control recording of signals of the selected broadcast channel on a recording medium in accordance with the table.

2. The recording controller of claim 1 further comprising:
a storage module configured to store program information in the signals of the selected broadcast channel; and
a program table generator configured to generate a program table corresponding to the plurality of broadcast channels based on the stored program information.

3. The recording controller of claim 2,
wherein the program table generator is configured to generate a program table separately indicating the recording time range and a range out of the recording time range in accordance with the table.

4. The recording controller of claim 1 further comprising:
a second table configured to indicate priorities of the signals of the broadcast channels to be recorded on the recording medium; and
a deletion module configured to delete signals of the selected broadcast channels from the recording medium in accordance with the priorities.

5. The recording controller of claim 4,
wherein the priorities are given to broadcast channels or recording time ranges.

6. The recording controller of claim 4,
wherein the priorities accompany information of programs corresponding to the broadcast channels; and
the deletion module is configured to delete the signals of the selected broadcast channels on program basis from the recording medium based on the accompanying information of the programs.

7. The recording controller of claim 1 further comprising:
a third table configured to indicate a single broadcast channel and a second recording time range for recording a signal of the single broadcast channel; and
a second recording controller configured to control recording of the signal of the single broadcast channel on the recording medium in accordance with the third table.

8. The recording controller of claim 7 further comprising:
an input module configured to input information indicating the presence or absence of recording of the signals of the selected broadcasts channel on the recording medium;
an area reservation module configured to reserve a first area for recording the signals of the selected broadcast channels and a second area for recording the signal of the single broadcast channel in accordance with the information.

9. The recording controller of claim 8,
wherein the area reservation module is configured to cancel the first area and to extend the second area, when the information indicates the absence of recording of the signals of the selected broadcast channels and both the first and second areas are reserved, and
wherein the area reservation module is configured to cancel a portion of the second area in order to reserve the first area, when the information indicates the presence of recording of the signals of the selected broadcast channels and only the second area is reserved.

10. A recording control method comprising:
simultaneously presenting a first item for selecting a broadcast channel to be recorded from a plurality of broadcast channels and a second item for setting a recording time range in accordance with the selected broadcast channel; and
controlling recording of signals of the selected broadcast channel on a recording medium in accordance with a table comprising the selected broadcast channel and the recording time range.
